(19) United States
(12) Patent Application Publication
(10) Pub. No.: US 2019/0251830 A1
(43) Pub. Date: Aug. 15, 2019

(54) LOCALIZED DISTRIBUTION OF EMERGENCY MASS NOTIFICATION ALERTS

(71) Applicant: Federal Signal Corporation, Oak Brook, IL (US)

(72) Inventors: Jorge Manuel Jacinto Guerreiro, Oak Brook, IL (US); Michael K. Pula, Naperville, IL (US); Dana Edward Johnson, Tinley Park, IL (US); Scott Thomas Rohrbaugh, Bellevue, WA (US)

(21) Appl. No.: 16/276,879

(22) Filed: Feb. 15, 2019

Related U.S. Application Data
(60) Provisional application No. 62/631,094, filed on Feb. 15, 2018.

(51) Int. Cl. G08B 25/01; G06F 9/54; G06F 16/9035; G06F 16/909

(52) U.S. Cl. CPC G08B 25/016; G06F 16/909; G06F 16/9035; G06F 9/542

(57) ABSTRACT

In an example, a notification system includes: a first notification server that is programmed to originate emergency messages; a second notification server connected to the first notification server, the second network server being programmed to identify the target endpoints associated with the emergency messages; and a virtual personal assistant-enabled device programmed to receive the emergency messages from the second notification server, translate the emergency messages into a format suitable for issuance by the virtual personal assistant-enable device, and issue the emergency message.

### RELATED APPLICATION(S)

This patent application claims the benefit of U.S. Patent Application No. 62/631,094 filed on Feb. 15, 2018, the entirety of which is hereby incorporated by reference.

### BACKGROUND

Initially designed to warn of air raids in World War II, civil defense sirens (also known as air-raid sirens or tornado sirens) were adapted to warn of nuclear attack and of destructive weather patterns, such as tornadoes. The non-message-specific nature of the sirens led to many of them being replaced with more specialized warnings, such as the Emergency Alert System (EAS). Many of these sirens were installed decades ago when population density was lower and building construction had less insulation and sound proofing, allowing the outside sirens to penetrate and be heard indoors.

Because of ongoing growth in population, steady increases in urbanization, and the corresponding construction of multi-story buildings, as well as increases in external sound attenuation provided by modern materials, as well as the continuing presence of natural obstacles such as trees, the interior effect of many outdoor warning sirens is diminished for all but the closest of buildings to the source sirens.

### SUMMARY

In one aspect, an example notification system includes: a first notification server that is programmed to originate emergency messages; a second notification server connected to the first notification server, the second network server being programmed to identify the target endpoints associated with the emergency messages; and a virtual personal assistant-enabled device programmed to receive the emergency messages from the second notification server, translate the emergency messages into a format suitable for issuance by the virtual personal assistant-enable device, and issue the emergency message.

### DESCRIPTION OF DRAWINGS

FIG. 1 shows an example notification system for an outdoor environment.

FIG. 2 shows an example notification system for an indoor environment.

FIG. 3 shows an example notification system combining the notification systems of FIGS. 1-2.

FIG. 4 shows an example method for enabling emergency message notification functionality on a virtual personal assistant-enabled device.

FIG. 5 shows an example method for issuing emergency messages on a virtual personal assistant-enabled device.

FIG. 6 shows an example method for initiating a subscriber-initiated request for emergency assistance from a trusted agency on a virtual personal assistant-enabled device.

FIG. 7 shows another example method for initiating a subscriber-initiated request for emergency assistance from a trusted agency on a virtual personal assistant-enabled device.

FIG. 8 shows an example user interface allowing a controller to select geographic areas for alerting.

FIG. 9 shows an example user interface allowing a user to configure virtual personal assistant-enabled devices for alerting.

### DETAILED DESCRIPTION

This disclosure addresses the problem of emergency notification awareness, specifically within structures. In examples provided herein, emergency notification systems ensure that alerting of events that trigger outdoor notifications can reach tenants inside of buildings (residential and/or commercial).

Gartner forecasts worldwide spending on Virtual Personal Assistant (VPA)-enabled devices (Smart Speakers) will top $3.5 billion by 2021. Users surveyed indicate that 57% of the questions to VPA-enabled devices are about weather. The paradigm of hearing severe weather outdoor emergency notifications and turning on a television or turning to an AM radio station is changing. Traditional broadcast television viewership is shrinking, and radios are disappearing in favor of smart devices, including phones, watches and personal appliances like VPA-enabled devices.

The embodiments disclosed herein propose the use of a VPA-enabled device such as the Echo product family from Amazon, Inc. or the Google Home product family from Google Inc. as an audio output device for alerting and notifications. This paradigm can also be extended to other VPA-enabled devices.

In addition, non-VPA-enabled devices, such as the First Alert Onelink smoke & carbon monoxide detector from BRK Brands, Inc., are able to incorporate the Amazon Alexa engine, so such devices can be treated as an extension of the VPA-enabled category because they also include a speaker for annunciation of alerts and threats. Further, many home and work devices incorporate VPA-like functionality, such as Google Assistant. Further devices like the Amazon Show/Fire TV, Google Chromecast, Sonos, and Apple TV are all connected devices that could include emergency notification integration.

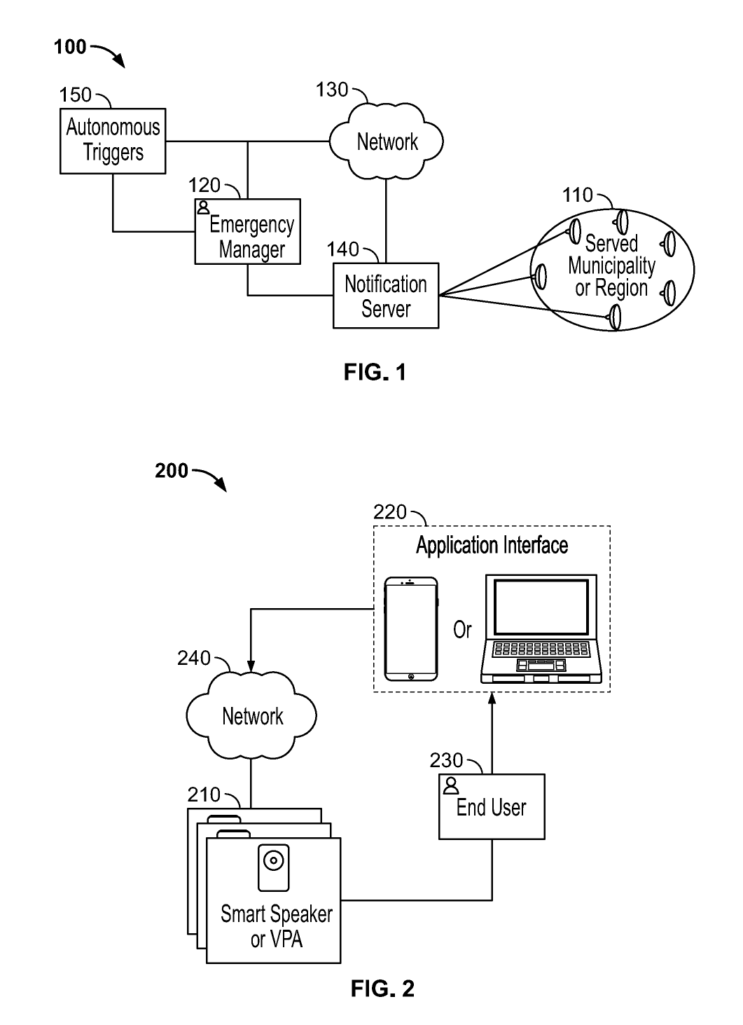

Audible outdoor warning systems 100, such as that depicted in FIG. 1, are used by public safety agencies to alert people about natural and manmade hazards, such as extreme weather conditions, flooding, nuclear accidents, and chemical spills. Sirens 110 are the most widely used sound-making device for inclusion in an audible outdoor warning system. Sirens 110 generate sound through mechanical, electromechanical, or electronic means and can produce audible signals ranging from tones of varying pitch, frequency, and duration to pre-recorded and live voice messages.

In its simplest form, the emergency mass notification system 100 is triggered by an emergency manager 120 responsible for activating the sirens 110 in a served municipality or region (see FIG. 1). Newer capabilities may allow for the emergency manager 120 to remotely activate a system through a cloud network 130 or distributed communications system connected to a notification server 140. The emergency manager 120 is defined as a person or programmatic interface (or AI application) with the authority to activate the sirens for that region.

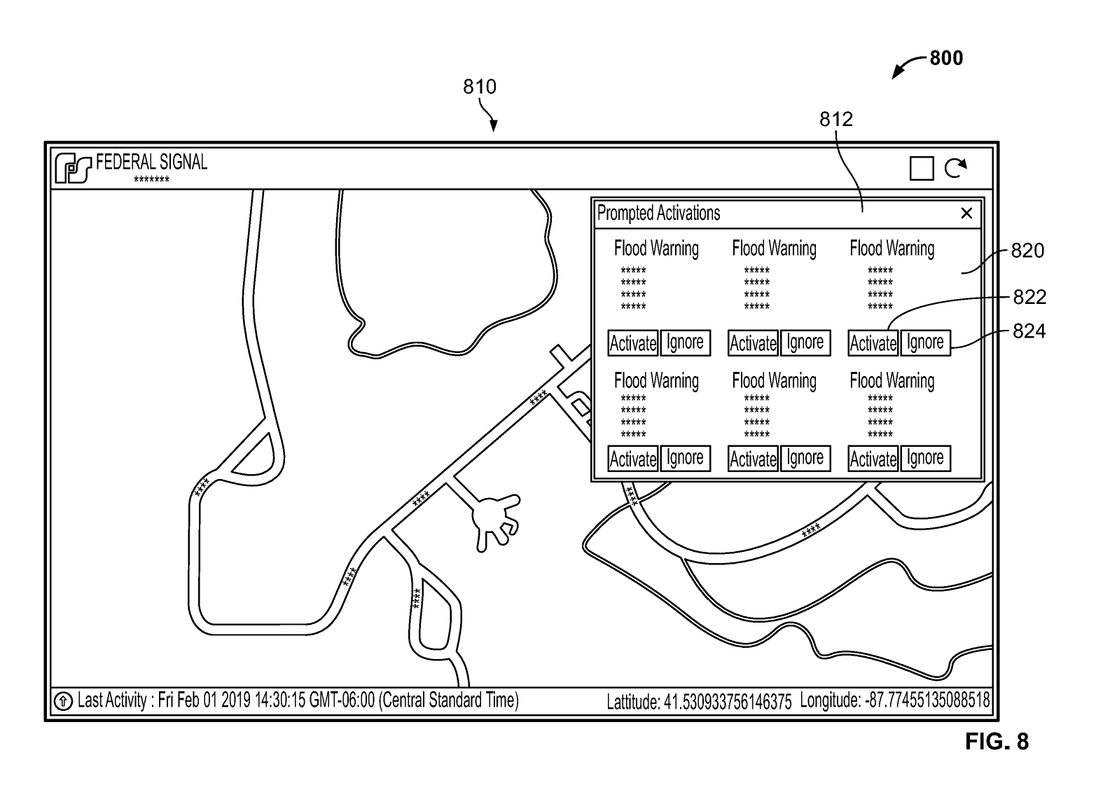

For example, a graphical user interface 800 is shown in FIG. 8. In this example, the interface 800 provides a location map 810 of a specific geographic region for alerting purposes. A pop-up box 812 provides the emergency manager 120 with a series of trigger locations. For example, a location 820 is listed along with the type of emergency and start/end times for the emergency notification. Once the location 820 is selected, the location map 810 for that location is loaded. The emergency manager 120 can select an activate control 822 to provide alarming for that location 820, or an ignore control 824 to suppress alerting for that location 820.

Referring again to FIG. 1, autonomous triggers 150 may be considered any event trigger that can be seen, felt, heard or distilled through analytical or meteorological information such as might be ingested from services including but not limited to Federal Emergency Management Agency (FEMA), Integrated Public Alert and Warning System (IPAWS), Emergency Alert System (EAS), National Warning System (NAWAS), National Oceanic and Atmospheric Administration (NOAA), or Wireless Emergency Alerts (WEA). The notification server 140 is defined as a computing device either on premise or set of multiple computing devices distributed throughout a geographic region.

If the sirens 110 are activated when a regular siren test is not scheduled, the public should see it as a signal to seek shelter, tune in to radio or television to get information about the type of emergency as well as instructions and recommendations; and tune in to local media for indications that the emergency is over. But traditional portals to local media (radios and televisions) are increasingly absent from American households.

One example of such a notification system 100 is the CommanderOne® offering for cloud-based emergency and Emergency Mass Notification System (EMNS) from Federal Signal Corporation of Oak Brook, Ill. Also related is U.S. Pat. No. 7,746,794, “Integrated Municipal Management Console,” which is incorporated herein in its entirety.

Alternatives to radio and television include Wireless Emergency Alerts (WEA) that are designed to alert mobile users in the United States about kidnappings (Amber Alerts), severe weather, and national emergency alerts (Presidential announcements). Alerts are geographically targeted, meaning users will not receive notifications for emergencies that have no relevance at the location of the user (i.e., a missing child in San Francisco will not produce an Amber Alert in New York, etc.). The system has proven to be helpful in warning people about dangerous situations, but alerts have also been known to reach phones after overly-long delays. Further, phones that are turned off or in silent mode—or not with the user—will not convey timely alerts.

Experts believe that, in the context of severe emergencies, more alerting (spanning different modalities) is better than less—and could potentially prevent loss of life and/or property. Keeping with that spirit, the embodiments described herein extend emergency notification alerts through sounds and spoken words to VPA-enabled devices, which are already present in many residential premises and are rapidly proliferating into commercial spaces.

FIG. 2 shows another notification system 200 with a logical connection between an end-user or owner 230, a network 240 that contains programming logic and customization software, and one or more VPA-enabled devices 210. Users 230 may be required to employ a computing device (e.g., mobile device) to access an application 220 to modify settings that are stored in the cloud network and are used to affect their devices 210. Verbal commands are ingested by the device 210 and either interpreted locally or sent into the cloud network 130 for further processing. The application 220 is a trusted software program that serves to enable permissions, customize as well as control the smart speaker/VPA.

The user/owner 230 of the smart speaker device 210 is responsible for enabling the VPA application on the device 210. The user 230 is also in control of the level, repetition, permissions, and, if possible, the positive acknowledgement of the alert if that capability is programmed into the VPA application 220 used to control the device 210.

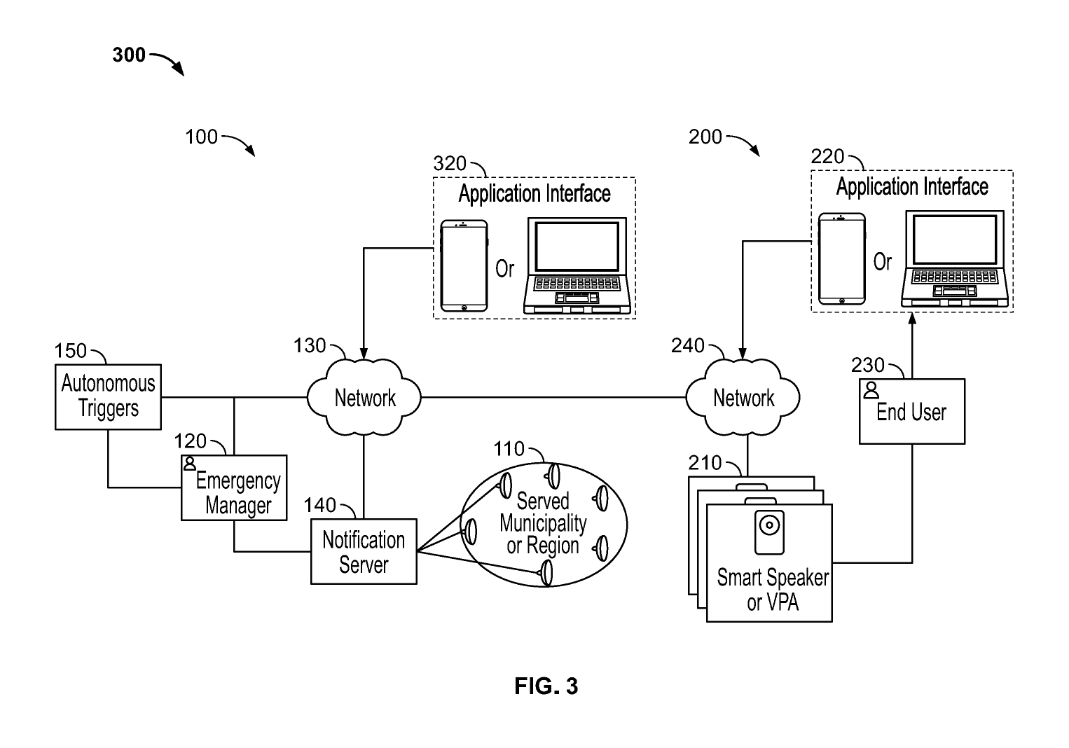

Taking a phased approach would allow such service offerings to evolve along with various other resources and ecosystem partners. FIG. 3 shows an example notification system 300 with the cloud network 130 to network 240 interchange to make this possible joining the outdoor notification system 100 with the indoor notification system 200.

A basic implementation of the concept would be a VPA application that would simply allow a customer to be notified whenever the outdoor system 100 was triggered. The end-user would invoke loading the VPA application (e.g., “Alexa, enable Federal Signal Notification”) in the normal means. The VPA application could be written such that loading it (the VPA application) compares the installed device zip code to the Commander offering geography and returns success or failure for activation. The user/owner 230 may be asked via the application interface 220 to provide or confirm their geographic location by providing street address or zip code. Alternately, location by IP address (e.g., provide a best guess approximation of the latitude and longitude of the customer location) provided by the Internet Service Provider (ISP) may be a semi-transparent implementation of geo-location.

A next iteration of the concept would be the basic implementation as well as a customer portal to allow customization of alerts, number of repeats (e.g., 1 to 99, where 99 is repeat indefinitely) before automatic or manual cancellation, ability to trigger additional VPA-enabled devices in the same location (via linking code), and an option to acknowledge receipt of notification.

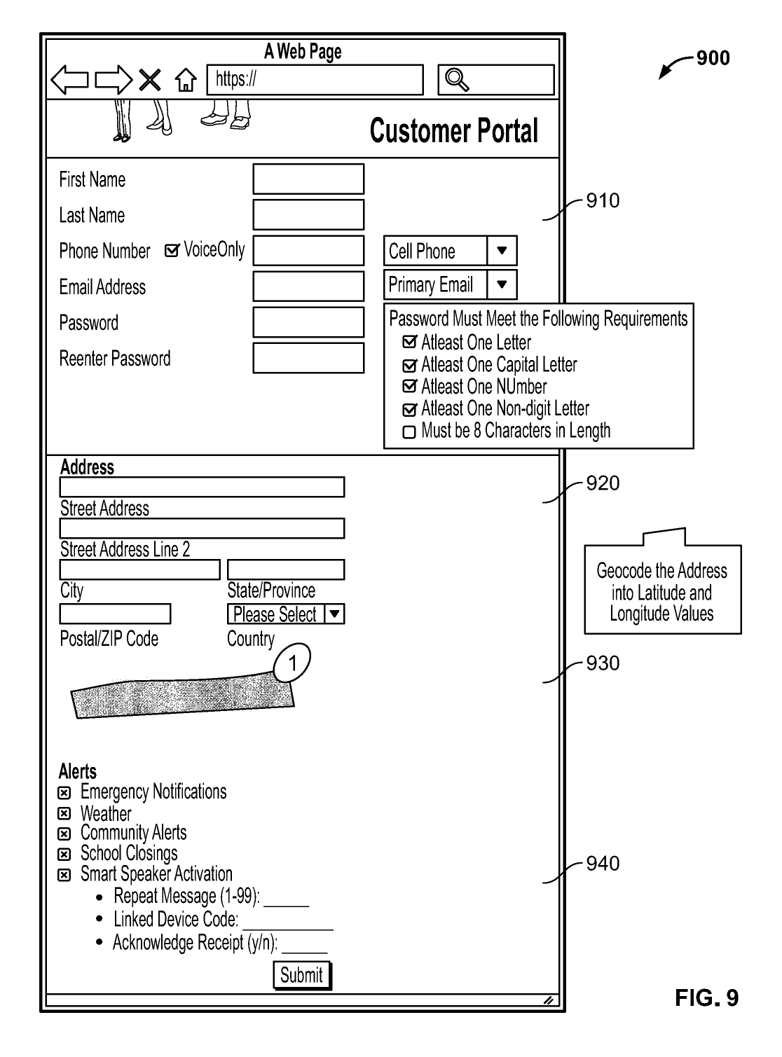

An example graphical user interface 900 for allowing the user/owner 230 to enroll the VPA-enabled device 210 is shown in FIG. 9. In this example, the user/owner 230 accesses the interface 900 using a computing device, such as a smartphone, tablet, laptop, or other similar computing device. The user/owner 230 provides bibliographic information at sections 910 and 920 of the interface 900, including name, contact information, and address. At section 930 of the interface 900, a map of the selected area is shown. The location information can be automatically populated using technologies like GPS, geocoding, etc.

At section 940 of the interface 900, the user/owner 230 can configure the alerting functionality provided by the VPA-enabled device or devices 210 associated with the user/owner 230. In this example, the user can configure such notification aspects as the type of notifications (e.g., emergency, weather, community alerts, school closings, etc.) and the type of alerting provided (e.g., repeat alerting, linking of multiple devices, and acknowledgement requirements for a notification).

In other examples, other configuration settings are possible. For example, the interface can provide the user with the ability to customize characteristics of the audible/visual message, such as to select gender specific and language specific playback, volume, brightness or color preference. In other examples, the settings can also allow the user to distinctly control and allow the voice, timbre, volume, and inflection used for emergency alerting to be separate from that used for daily playback of music or other interaction. Other configurations are possible. Municipal agencies could have the ability to customize, brand and extend these capabilities to serve their demographics.

A further-developed version of the offering would implement the above offerings and enable expanded notification applications with municipal and community sources of information that can be selected through and customized by the consumer via the portal. This offering would bring additional value for incidents such as:

a. School closings

b. Police/Fire incidents nearby

c. Proactive weather notifications

d. Traffic incidents nearby

e. Others to be determined

The utility of the application created through customization would increase significantly with each subsequent approach, by allowing each user to obtain progressive control over information they desire. The insight returned to the entities providing the alerting (e.g., Federal Signal Corporation) from utilization and subscription could help drive additional features, maintenance and application extensions and value.

In the illustrated example, the networks 130 and 240 associated with the notification system 300 can be independently owned and operated. The notifications services are provided by each without knowledge of the internal workings of each system, except that end user 230 with VPA-enabled device 210 has an account on the network 240 and wants notification services provided by the network 130.

Accounting linking is a method of authorizing and transforming information from one network (e.g., the network 130) to the other network (e.g., the network 240) on behalf of the end user. It also authorizes network 130 to provide stimuli through the network 240 that may take priority or supersede transactional information flow that may be occurring between the end user 230, the VPA-enabled device 210, and the network 240.

Conformant to Internet Engineering Task Force (IETF) RFC 6749 specifies the OAuth authorization framework to enable third-party secure account linking and RFC 7662 for token introspection between the customer portal and the VPA-enabled device, a method of account linking that connects the identity of the VPA owner with his/her user account on the notification system 300 will be employed. Other established methods including “Login with Amazon”, “Google Sync”, or others may similarly be utilized to establish linkage between device ownership and the notification system 300.

The table below shows an example schema for authentication between remote servers (containing end user credentials) and the notification system 300 (containing end user portal subscription information).

| Field | Value | Type |
|---|---|---|
| Authorization URI | Customer Portal | URI String |
| Access Code URI | Access Token Site | URI String |
| Client Identification | User Name on Portal | String |
| Client Secret | Password | String encrypted |
| Client Authentication | Credentials | JSON embedded |
| Last Name | Customer Surname | String |
| First Name | Customer Given Name | String |
| Street Address | Full Street Address | String parsed |
| | | numeric/alpha |
| City | Customer City Name | String |
| State | Customer State Name | String |
| Zip Code | Customer Zip Code | Numeric |
| Country | Customer Country | String |
| Phone Number | Customer Phone | Numeric |
| Notification | Comma Separated Values | String |
| Preferences | | |
| Smart Speaker | Comma Separated Values | String |
| Preferences | | |
| Account Linking | Linking Value | String encrypted |
| Authorization | | |

Authorization and Access Code Universal Resource Identifiers (URIs) refer to the web addresses by name or in Uniform Resource Locator (URL) format of the respective network servers. This information can be populated through a portal interface 320 by end user 230, accessed using a computing device, to collect information about the end user, including, but not limited to, geographic location specified by address, city, state and/or zip code; notification preferences which may include weather, community events, school closings, disasters and extent of coverage to broaden or narrow the notifications about surrounding areas. Also included is a means of specifying VPA-enabled device 210 alerting and account linking authorization to bond this end user's account to the account controlling the VPA-enabled device 210.

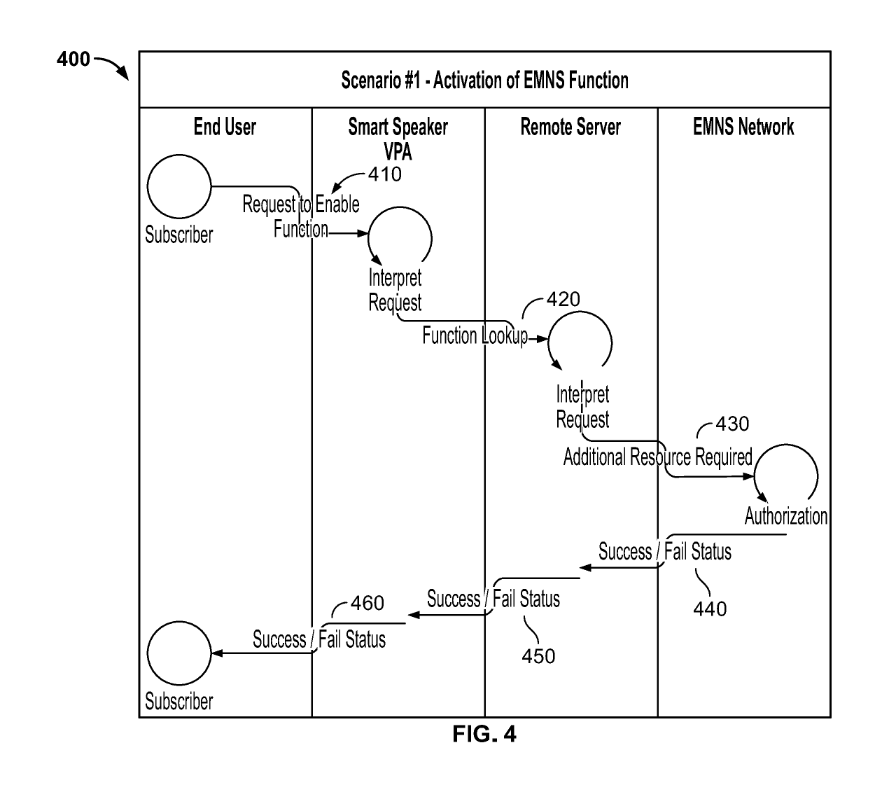

FIG. 4 shows a typical method 400 for activation of a function or capability through a smart speaker or VPA. It should be noted that the end user may verbally communicate with the VPA-enabled device directly and/or may utilize additional setup/configuration options on the mobile device or through a web page to supply ancillary information such as notification preferences, home address, login/password information or other pieces of information necessary for the function to operate.

At operation 410 of the interchange 400 of FIG. 4, the user issues a request (orally or through a graphical user interface, such as that shown in FIG. 9) for specific alerting functionality on a VPA-enabled device. At operation 420, the VPA-enabled device queries the network, and the network queries the emergency network at operation 430. Success or failure is passed back to the user through operations 440, 450, 460.

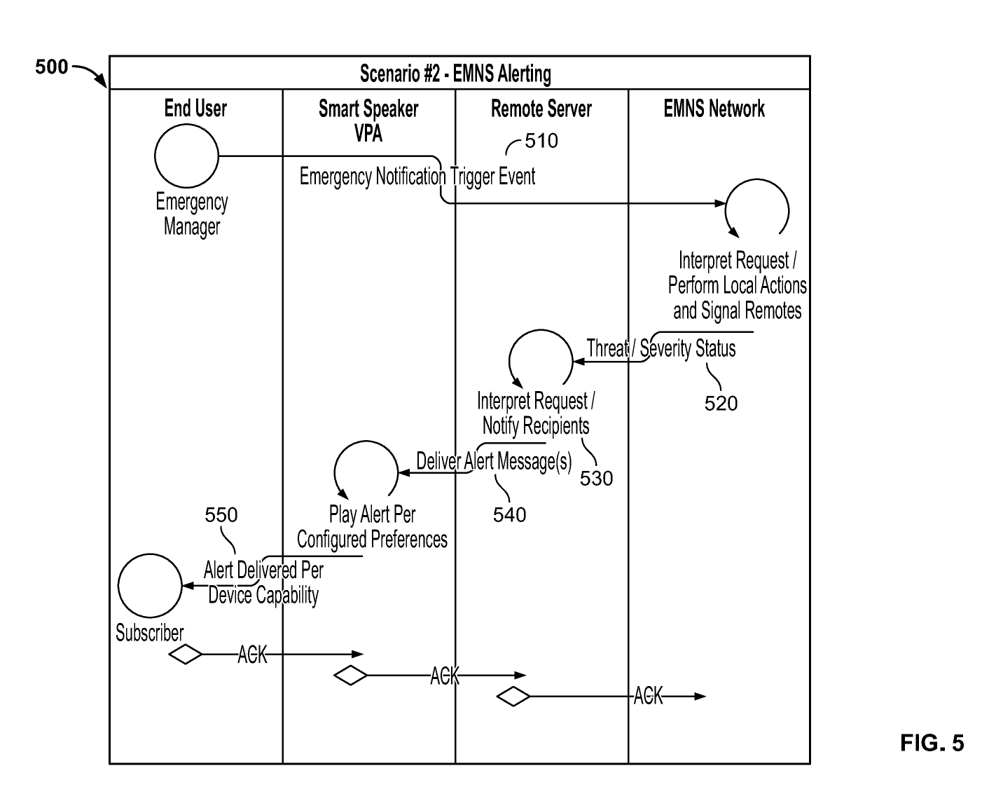

FIG. 5 shows an example method 500 for the initiation of an emergency notification event that could be triggered by an emergency manager or another trusted source at an operation 510. The request is handled by the EMNS network at operation 520, which is responsible for activating outdoor warning sirens. Additionally, the EMNS network will send activation messages to all known remote servers in the same geography at operations 530, 540, responsible for smart speaker/VPA devices. These devices will light, play and/or display the relevant emergency alerting notification based on its capabilities and configuration at operation 550. If configured, the alerting notification may repeat based on settings and may require an acknowledgement to stop the alert from continuing.

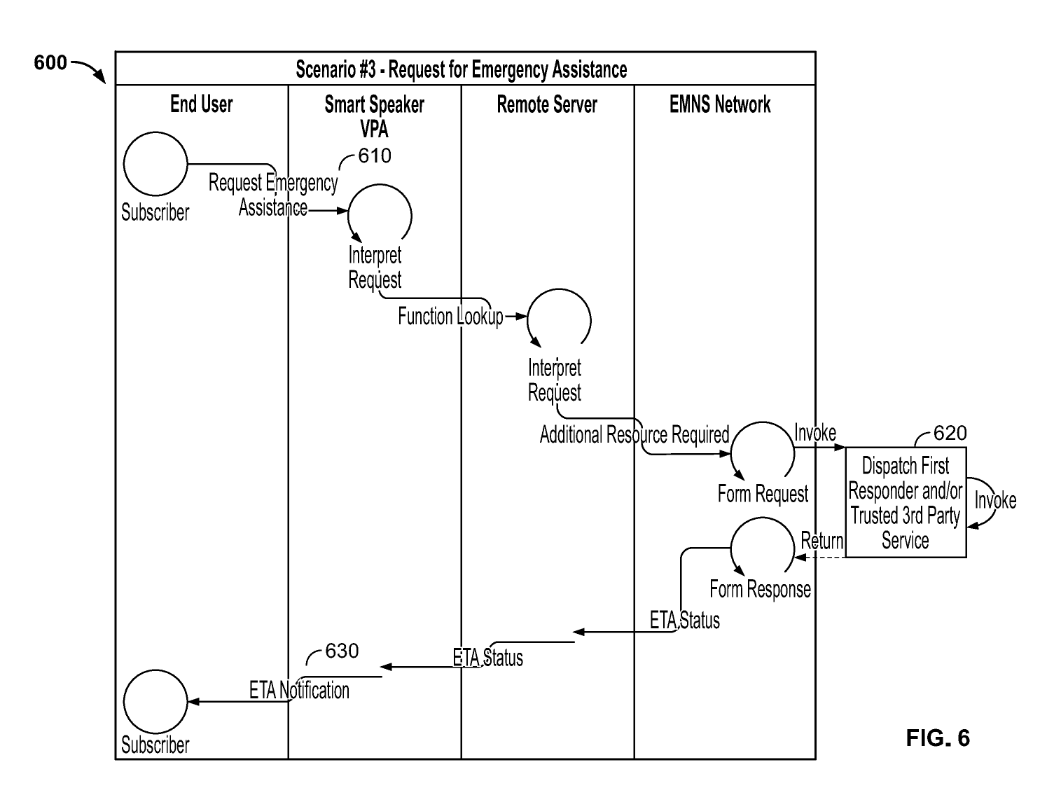

FIG. 6 shows an example method 600 for a subscriber-initiated request for emergency assistance, where confirmation of request receipt and response action is returned to that subscriber. One example scenario is a subscriber has fallen and cannot reach a telephone but instead tells his/her VPA-enabled device to send assistance. The information is processed, communication channel open and emergency dispatch confirms that an ambulance is enroute with arrival in a short amount of time (e.g., 3 minutes).

The subscriber may initiate a 911 emergency or request a trusted third party (agency, caregiver, family member) through the VPA-enabled device at operation 610. The EMNS network recognizes that this is a request initiated by a subscriber rather than emergency manager and forwards the request outside the network with subscriber location information to a dispatch service at operation 620, which can triage the request, notify appropriate personnel and/or dispatch emergency services to that address. A messaging series can provide the initiator with an estimated time of arrival notification at operation 630. Additionally, as part and parcel of the same request, and within the same quantum, the request for assistance notification may be remitted to loved ones, and/or interested parties, via configuration settings established by user a priori.

The notification coming out of the EMNS may take the form of any known messaging method available at this time, including but not limited to SMS text, email, any digital form, output on someone else's VPA-enabled device, or other emergency management outlets such as audio-visual devices that may be connected and part of the EMNS network. The response to the subscriber indicates how the request will be handled in the form of a spoken message and/or displayed text.

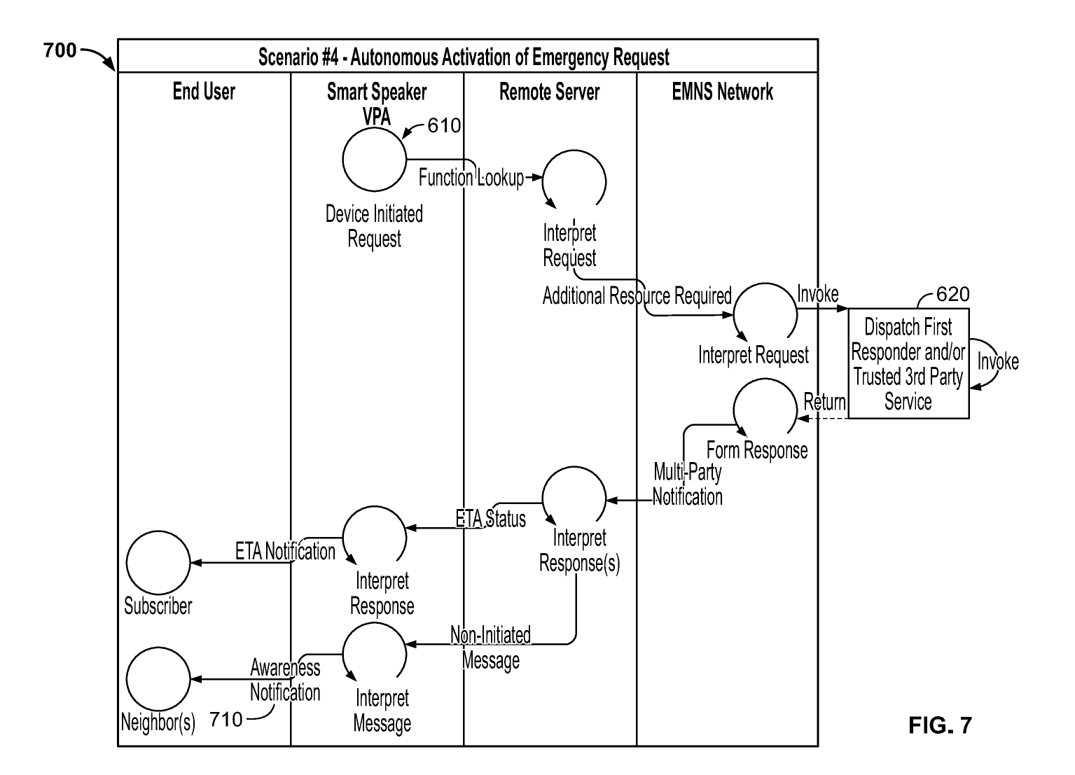

FIG. 7 shows an example method 700 illustrating another example of how a device-initiated request (VPA-enabled devices or other sensors) can be processed, where confirmation is returned to that subscriber as well as notifying the neighbor, friends, family or other contacts setup in his/her notification criteria. Similar to the above scenario of FIG. 6, emergency dispatch confirms to the subscriber as well as the listed contacts.

When an emergency event such as fire, gun shots, gas leaks, etc. are detected, a request through the remote server into the EMNS network can help dispatch the appropriate response team (fire, police, etc.) and alert the subscriber to actions being taken on their behalf, as well as alert trusted third parties, neighbors etc. through their own connected devices, text, email, social media, etc. at operation 710. The user may have the opportunity to cancel the alarm and pending actions if a false notification has been triggered.

Current designs of the VPA-enabled devices typically utilize an array of microphones to pick up sound from any direction in the room. Beam forming is used to ascertain the direction of the loudest signal with noise cancellation employed to the other microphone in order to fix on the sound (which is typically spoken words). In the event that a gunshot occurs, the microphone array can not only obtain an azimuthal fix on that sound but also capture the waveform (i.e., the signature of the shot), relay that digital waveform to the remote server that in turn relays that to the EMNS as shown in FIG. 7.

The remote server can compare the signature of the waveform against other sound samples to rule-out balloon pops or other similar noises to avoid false alarms. Remote sensors with the ability to detect gas leaks, smoke, carbon monoxide, and water leaks may not be integrated into standard VPA hardware, and therefore may be optionally added and joined to the VPA device with Bluetooth connectivity, Zigbee or other networking means.

There can be various advantages associated with this disclosure. For example, generational changes, understanding and trust of the civilian population have lead us to the conclusion that the old paradigms are no longer effective. Older generation adults familiar with cold war threats rely on outdoor warning sirens. Younger generations may not have been exposed and are unaware of the implications and procedures for taking shelter. Millennials prefer specific attention and personalized alerts and are more comfortable with and trust technology (especially if it speaks directly to them). Verbal or visual messages that provide specifics with location information such as “A tornado/funnel cloud was spotted on 5^{th} and Main” emanating from a device in a residence provides more credibility than a broadcast siren or television alert with confusing tornado watch versus tornado warning messages for an entire region.

Further, if smart speakers and associated emergency alerting employ a positive acknowledgement dialogue then a tally of occupants might be available to first responders who would then know if occupants received an alert, acknowledged and vacated or remained in place. This is often the case in hurricane vicinities. Further, users might also indicate number of occupants and if there are any special needs cases such as wheel chairs, bed-ridden individuals or even family pets. Knowing who may still occupy a building could help first responders direct their resources more efficiently, save more lives and reduce the cost of rescue operations.

The VPA-enabled devices 210 described herein can include at least one central processing unit (“CPU” or GPU or any other computational engine for processing instructions), also referred to as a processor, a system memory, and a system bus. The system memory may include a random-access memory (“RAM”) and/or read-only memory (“ROM”). The devices may further include a mass storage device that is able to store software instructions and data.

The mass storage device is connected to the CPU through the system bus. The mass storage device and its associated computer-readable data storage media provide non-volatile, non-transitory storage for the devices. Although the description of computer-readable data storage media contained herein refers to a mass storage device, such as a hard disk or solid-state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the devices.

According to various embodiments, the devices described herein may operate in a networked environment using logical connections to remote network devices through the network, such as a wireless network, the Internet, or another type of network. The devices may also include an input/output controller for receiving and processing input from a number of other devices, including a touch user interface display screen, or another type of input device. Similarly, the input/output controller may provide output to a touch user interface display screen or other type of output device.

As mentioned briefly above, the mass storage device and the RAM of the devices described herein can store software instructions and data. The software instructions include an operating system suitable for controlling the operation of the devices. The mass storage device and/or the RAM also store software instructions and software applications, that when executed by the CPU, cause the devices to provide the functionality discussed in this document.

What is claimed is:

1. A notification system, comprising:
a first notification server that is programmed to originate emergency messages;
a second notification server connected to the first notification server, the second network server being programmed to identify the target endpoints associated with the emergency messages; and
a virtual personal assistant-enabled device programmed to receive the emergency messages from the second notification server, translate the emergency messages into a format suitable for issuance by the virtual personal assistant-enable device, and issue the emergency message.

2. The notification system of claim 1, wherein the virtual personal assistant-enabled device is programmed to issue the emergency message in an audible or visual format.

3. The notification system of claim 1, wherein the first notification server ranks, sequences, pre-empts, and expedites the emergency messages.

4. The notification system of claim 1, wherein the virtual personal assistant-enable device is programmed to issue emergency messages including:
regional emergency notifications;
local emergency notifications;
targeted notifications, including reverse-911 calls; and
pre-loaded emergency messages.

5. The notification system of claim 1, wherein the virtual personal assistant-enable device includes:
a speaker to issue audible messages;
one or more lights or a display to issue visual messages;

6. The notification system of claim 5, wherein the display of the virtual personal assistant-enable device is configured to display text-based and image-based message.

7. The notification system of claim 5, wherein the virtual personal assistant-enable device is configurable to allow for selection of gender specific and language specific playback, volume, brightness or color preference.

8. The notification system of claim 5 where the virtual personal assistant-enable device is configurable to control voice, timbre, volume, and inflection used for emergency alerting to be separate from that used for daily playback of music or other interactions.

9. The notification system of claim 1, wherein the emergency messages are conveyed once, a finite number of times at regular intervals, or an indefinite number of times at regular intervals between messages.

10. The notification system of claim 1, wherein the virtual personal assistant-enable device is further programmed to receive spoken audio communication from nearby users in order to:
initiate 911 calls;
receive verbal confirmation of receipt of earlier emergency messages; and
create a bi-directional full- or half-duplex verbal messaging to emergency management personnel.

11. The notification system of claim 1, wherein the virtual personal assistant-enable device is further programmed to convert the emergency messages to alternate formats and re-transmitted to various recipients via SMS text message, email, or smart speaker messages.

12. The notification system of claim 1, wherein the virtual personal assistant-enable device is further programmed to detect various emergency conditions, including:
gunshots;
fire;
hazardous gaseous emissions; and
flooding.

13. The notification system of claim 10, wherein the virtual personal assistant-enable device is further programmed to convey the various emergency conditions to local emergency services personnel and/or nearby residential and commercial properties.

14. The notification system of claim 1, wherein the second notification server is further programmed to convey the emergency messages to target endpoints within a narrowly prescribed geographic area, as determined directly by address information associated with each virtual personal assistant-enabled device.

15. The notification system of claim 13, wherein the address information is determined based upon an address or assumed location based upon an IP address of the virtual personal assistant-enabled device.

16. The notification system of claim 1, wherein the virtual personal assistant-enabled device is further programmed to allow for subscription to emergency messages for certain geographic locations.

17. A notification system, comprising:
a first notification server that is programmed to originate emergency messages;
a second notification server connected to the first notification server, the second network server being programmed to identify the target endpoints associated with the emergency messages; and
a virtual personal assistant-enabled device programmed to receive the emergency messages from the second notification server, translate the emergency messages into a format suitable for issuance by the virtual personal assistant-enable device, and issue the emergency message;
wherein the virtual personal assistant-enabled device is programmed to issue the emergency message in an audible or visual format; and
wherein the first notification server ranks, sequences, pre-empts, and expedites the emergency messages.

18. A method for issuing notification, the method comprising:
providing a first notification server that is programmed to originate emergency messages;
connecting the first notification server to a second notification, the second network server being programmed to identify the target endpoints associated with the emergency messages;
receiving, at a virtual personal assistant-enabled device programmed, the emergency messages from the second notification server;
translating the emergency messages into a format suitable for issuance by the virtual personal assistant-enable device; and
issuing the emergency message.

19. The method of claim 18, wherein the virtual personal assistant-enabled device is programmed to issue the emergency message in an audible or visual format.

20. The method of claim 18, wherein the first notification server ranks, sequences, pre-empts, and expedites the emergency messages.
